(19) United States
(12) Patent Application Publication
(10) Pub. No.: US 2011/0097570 A1
(43) Pub. Date: Apr. 28, 2011

(54) WEAR AND CORROSION RESISTANT ZEOLITE COATING

(76) Inventors: Yushan Yan, Riverside, CA (US); Junlan Wang, Bellevue, WA (US); Gabriel Chow, Petaluma, CA (US)

(21) Appl. No.: 12/914,854

(22) Filed: Oct. 28, 2010

Related U.S. Application Data
(60) Provisional application No. 61/255,814, filed on Oct. 28, 2009.

(51) Int. Cl. B32B 15/04; B32B 3/26; B32B 5/00; B05D 1/18; B05D 3/02

(52) U.S. Cl. 428/312.6; 428/450; 428/447; 428/332; 427/435; 427/352

(57) ABSTRACT

The present invention provides a wear and/or corrosion-resistant zeolite coating for protection of the surface of a substrate of a metal.

### CROSS-REFERENCES TO RELATED APPLICATIONS

This application claims priority to U.S. Provisional Patent Application No. 61,255,814, filed Oct. 28, 2009, which is incorporated herein by reference in its entirety for all purposes.

### STATEMENT AS TO RIGHTS TO INVENTIONS MADE UNDER FEDERALLY SPONSORED RESEARCH AND DEVELOPMENT

This invention was made with Government support under Grant No. DACA72-03-C 0007, awarded by the Department of Defense. The Government has certain rights in this invention.

### BACKGROUND OF THE INVENTION

Wear and corrosion resistant coatings are often used to protect industrial metals such as steel and aluminum from degradation. In this field, chromium (Cr) and cadmium (Cd) coatings are extensively used, with chromium setting the standard in wear resistance and cadmium being the choice for mild corrosion resistance. However in recent decades, both chromium and cadmium have come under scrutiny for health and environmental issues presented during their respective coating processes. Some of the most promising current alternatives include tungsten alloy coatings to replace chromium and electroplated zinc alloy coatings to replace cadmium, but debilitating limitations still remain. Wear resistant tungsten alloy coatings are deposited by a line-of-sight type plasma spray, which can encounter difficulty in complex part geometries. Zinc deposition still centers on an unwanted electrochemical process with subsequent chromate treatments necessary for full levels of corrosion resistance.

Therefore, there is a need to develop new corrosion and wear-resistant coatings that are environmentally benign and exhibit comparable or superior properties than known chromium, cadmium and other coatings. Surprisingly, the present invention meet these and other needs.

### BRIEF SUMMARY OF THE INVENTION

The present invention provides corrosion and/or wear-resistant coatings, which are useful for protection of the surface of a substrate of a metal. In accordance with an exemplary embodiment, a hydrothermally synthesized wear and corrosion resistant zeolite coating (e.g., ZSM-5 coating) has been developed with the following advantages over chromium, cadmium, and their alternatives: (1) Synthesis process and final coating pose absolutely no threat to humans or the environment being virtually benign and eliminating electroplating altogether; (2) High hardness to modulus ratio giving greater coating flexibility with lower chance of cracking during substrate torsion and bending; (3) Superior wear resistance to cadmium in all conditions; (4) Superior wear resistance to chromium in most practical hard chrome applications; (5) Higher corrosion resistance than both chromium and cadmium by multiple orders of magnitude; and (6) Synthesis process coats all geometries evenly and effectively.

In one aspect, the present invention provides a composition of matter. The composition of matter includes a substrate of a metal that is susceptible to corrosion, wear or abrasion; and a corrosion and wear-resistant coating on the surface of the substrate, the coating including a polycrystalline zeolite. In one embodiment, the zeolite is porous. In another embodiment, the zeolite has intercrystal voids and/or intracrystal pores. The intercrystal voids can be sealed with a pore-sealing agent. The intracrystal pore can be filled with a pore-filing agent. In another embodiment, the zeolite is preferably non-porous with its polycrystalline structure rendered non-porous with a pore-sealing agent and/or a pore-filing agent. Exemplary pore-sealing agent includes a silane. Exemplary pore-filling agent includes an organic amine.

In another aspect, the present invention provides a method for preparing a wear-resistant zeolite coating on the surface of a metal. The method includes contacting a zeolite forming mixture with the surface of a metal under conditions sufficient to form a layer of zeolite coating on the surface of the metal. In one embodiment, zeolite formed is porous and has both intercrystal voids and/or intracrystal pores. The intercrystal voids can be sealed with a pore-sealing agent. The intracrystal pore can be filled with a pore-filing agent. In another embodiment, the zeolite is preferably non-porous with its polycrystalline structure rendered non-porous with a pore-sealing agent and/or a pore-filing agent. Exemplary pore-sealing agent includes a silane. Exemplary pore-filling agent includes an organic amine.

In another aspect, the present invention provides a method for protecting the surface of a substrate of a metal against corrosion, wear or abrasion. The method includes forming a layer of zeolite coating on the surface of the metal. In one embodiment, the method includes forming a porous zeolite on the surface of the metal to protect the metal surface against wear or abrasion. In another embodiment, the method includes forming a non-porous zeolite on the surface of the metal with a pore-sealing agent for the intercrystal voids and/or a pore-filing agent for the intracrystal pores. The pore-sealing agent and/or the pore-filling agent retained in the zeolite coating's structure to protect the metal surface against wear or abrasion. In yet another embodiment, the method includes forming a non-porous zeolite on the surface of the metal with a pore-sealing agent for the intercrystal voids and/or a pore-filing agent for the intracrystal pores. The pore-sealing agent and/or the pore-filling agent pore-filing agent retained in the zeolite coating's structure protect the metal surface against corrosion. Exemplary pore-sealing agent includes a silane. Exemplary pore-filling agent includes an organic amine.

### BRIEF DESCRIPTION OF THE DRAWINGS

FIGS. 1(A)-1(B) are scanning electron microscope (SEM) images of a zeolite topography (A) and a cross section (B), respectively.

FIG. 2 is a SEM image of a top view of a Cd coating, (top) unpolished, and (bottom) polished, respectively.

FIG. 3 is a SEM image of a cross-sectional view of a Cd coating, (top) unpolished, and (bottom) polished, respectively.

FIG. 4 is a SEM image of a top view of a Cr coating, (top) unpolished, and (bottom) polished.

FIG. 5 is a SEM image of a cross-sectional view of a Cr coating, (top) unpolished, and (bottom) polished.

FIG. 6 is a chart showing hardness (A) and elastic modulus (B) plotted versus contact depth from nanoindentations on all surfaces.

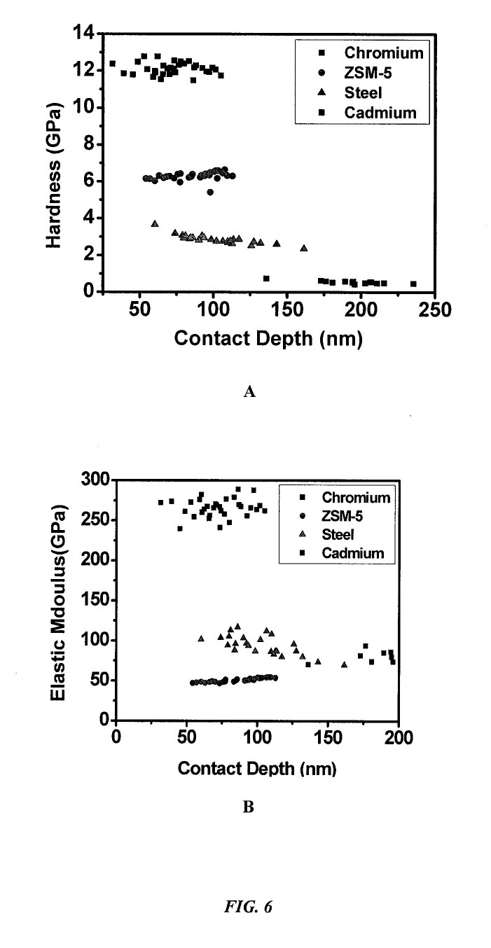

FIGS. 7(A)-7(B) are (A) scratch profiles (along scratch direction) for constant force 500 μN scratches on each surface, and (B) SPM images of 500 μN scratches on chromium(B₁), ZSM-5(B₂), steel(B₃), and cadmium(B₄), wherein images represent 10×10 μm area. Z-axis scale, chromium—26 nm/div; ZSM-5—22 nm/div; steel—54 nm/div; cadmium—210 nm/div., and wherein the cadmium and steel surfaces both exhibit significant visible deformation and larger profile depths indicating poor wear resistance.

FIG. 8 is a scratch profile for 1000 μN and 1500 μN scratches on ZSM-5 and chromium.

FIG. 9 is a chart showing percentage in depth difference among scratches on ZSM-5 and chromium for loads of 500-2500 μN.

FIGS. 10(A)-10(B) are chart showing (A) load-displacement plot of 500 μN indentations on Cr, Cd, steel 4130, and ZSM-5, wherein the Cd has significantly deeper indent depth than all of the other surfaces, dotted lines indicate the maximum depths on chromium and ZSM-5 (24.5±0.3 nm and 58.4±0.5 nm respectively), and arrows indicate final depths of chromium and ZSM-5 (9.6±0.1 nm and 5.0±0.4 nm respectively), and wherein ZSM-5 recovers from a much higher maximum depth to a lower final depth than chromium; and (B) percent recovery from maximum displacement of 500 μN indentations on each surface. ZSM-5 recovers over 90% of the maximum deformation.

FIG. 11 is a chart showing normal stresses generated during 500-3000 μN indentations on the ZSM-5 coating with berkovich tip. 500 μN-2500 μN represents range where the ZSM-5 coating is more wear resistant than chromium, and wherein the maximum stress was in the range of approximately ˜3.5 GPa.

FIG. 12 are SPM images showing nanoscratches with conical tip on chromium and ZSM-5, wherein all SPM images represent 10×10 μm area, black boxes represent scratch areas; and (A₁) 3 mN scratches on the Cr coating with deformation clearly visible, (B₁) 3 mN scratches on ZSM-5 with no visible deformation indicating full elastic recovery, (B₂) single centered 6 mN scratch on ZSM-5 with no clear wear track, (B₃) single 8 mN scratch on ZSM-5 with wear scar slightly visible. Z-axis scale: A₁ and B₁—10 nm/div; B₂—18 nm/div; B₃—13 nm/div.

FIG. 13 is a chart showing friction coefficients (kinetic) for 5 μm length scratches with 250-1500 μN loading range.

FIG. 14 is a chart showing direct current polarization test curves for ZSM-5, Chromium, Cadmium, and steel 4130; and wherein less current density (x-axis in left direction) indicates more corrosion protection therefore ZSM-5 is most corrosion resistant followed by chromium, then cadmium, and finally steel 4130.

### DETAILED DESCRIPTION OF THE INVENTION

As used herein, zeolites suitable for use in this invention include any zeolites that can be porous, non-porous or a combination thereof. There are two types of pores: intracrystal pores and intercrystal pores. In one embodiment, the zeolites are non-porous and contain pore filler species occupying the openings in the zeolite crystal structure and pore sealing agent for removing the intercrystal voids. The pore-filling species known in the art as “structure-directing agents” are particularly convenient for this purpose since they are commonly used in the preparation of synthetic zeolites. The pore sealing agent can be a silane as exemplified in the article: R. Cai, M. Sun, Z. Chen, R. Munoz, C. O'Neill, D. Beving, Y. Yan 2008. lonothermal synthesis of oriented zeolite AEL films and their application as corrosion-resistant coatings, Angew. Chem. Int. Ed. 47, 525-528 and U.S. Patent Publication No.: 20100119736, each of which is incorporated herein by reference. Accordingly, the most appropriate zeolites are synthetic zeolites, whose structure, properties, and methods of manufacture are known among those skilled in the art.

Using the three-letter code of the International Zeolite Association (http://www.iza-online.org/), some of the preferred zeolite structures (some followed in parentheses by their industry names) are those of MFI (ZSM-5), MEL (ZSM-11), MTW (ZSM-12), MTN (ZSM-39), MTT, RUT, ITW, FER, IFR, STT, STF, AFI, CFI, MWW, AST, ITE, CON, BEA, CHA, ISV, LTA. More preferably MFI, MEL, BEA, and MTW.

The topology of a given zeolite is conventionally identified by the X-ray diffraction pattern of the zeolite, and X-ray diffraction patterns of the zeolites given above are known and available in the literature for comparison. The International Zeolite Association website: http://www.iza-online.org has a comprehensive data base for X-ray diffraction data They are also available in the patent literature. For example, the X-ray diffraction patterns and methods of preparation of some of these zeolites are found in the patent literature as follows: MFI (ZSM-5): U.S. Pat. No. 3,702,886, Robert J. Argauer et al., Nov. 14, 1972 MEL (ZSM-11): U.S. Pat. No. 3,709,979, Pochen Chu, Jan. 9, 1973 MTW (ZSM-12): U.S. Pat. No. 3,832,449, Edward J. Rosinski et al., Aug. 27, 1974. The disclosures of each of these patents are incorporated herein by reference.

Phosphate-containing zeolites include aluminophosphates (commonly referred to in the industry as “AlPO₄” or “AlPO4”), silicoaluminophosphates (commonly referred to as “SAPO”), metal-containing aluminophosphates (commonly referred to as “MeAPO” where the atomic symbol for the metal is substituted for “Me”), and metal-containing silicoaluminophosphates (commonly referred to as “MeAPSO”). These zeolites are sometimes referred as molecular sieves. Aluminophosphates are formed from AlO₄ and PO₄ tetrahedra and have intracrystalline pore volumes and pore diameters comparable to those of zeolites. In one embodiment, phosphate-containing zeolites that are suitable for use in this invention are those that contain pore-filling members in the openings throughout the crystalline structure, and the same “structure-directing agents” as described herein. Examples of known phosphate-containing zeolites that are commercially available (from UOP LLC, Des Plaines, Ill., USA) and useful in the practice of this invention are those sold under the following names: AlPO4-5, AlPO4-8, AlPO4-11, AlPO4-17, AlPO4-20, AlPO4-31, AlPO4-41, SAPO-5, SAPO-11, SAPO-20, SAPO-34, SAPO-337, SAPO-35, SAPO-5, SAPO-40, SAPO-42, CoAPO-50.

The compositions, physical characteristics, properties, and methods of preparation of phosphate-containing zeolites are known to those skilled in the art and disclosed in readily available literature. The following United States patents, each of which is incorporated herein by reference, are examples of these disclosures: Wilson, S. T., et al., U.S. Pat. No. 4,310,440 (Union Carbide Corporation), issued Jan. 12, 1982; Lok, B. M., et al., U.S. Pat. No. 4,440,871 (Union Carbide Corporation), issued Apr. 3, 1984; Patton, R. L., et al., U.S. Pat. No. 4,473,663 (Union Carbide Corporation), issued Sep. 25, 1984; Messina, C. A., et al., U.S. Pat. No. 4,554,143 (Union Carbide Corporation), issued Nov. 19, 1985; Wilson S. T., et al., U.S. Pat. No. 4,456,029 (Union Carbide Corporation), issued Jan. 28, 1986; and Wilson, S. T., et al., U.S. Pat. No. 4,663,139 (Union Carbide Corporation), issued May 5, 1987. The disclosures of each of these patents are incorporated herein by reference.

In one aspect, the present invention provides a composition of matter. The composition of matter includes a substrate of a metal that is susceptible to wear or abrasion and a wear-resistant coating on the surface of the substrate. The coating includes a zeolite. In one embodiment, the zeolite possesses uniform pores with diameters in the range of either less than 2 nm or between 2 to 50 nm. Alternatively, the zeolite can be non-porous. The non-porous zeolite contains a pore-filing agent retained in its crystal structure with the size sufficient to render the zeolite non-porous and a pore sealing agent for closing off the intercrystal voids.

The pore-filling agent for any of the zeolites can be any species that will remain in the zeolite structure and reside in the pores, occupying sufficient pore volume to reduce the porosity of the zeolite substantially to zero. The term “substantially non-porous” means that the pore volume as measured by nitrogen porosimetry is negligible, and no water (or at most an amount that is insufficient to cause noticeable corrosion) can penetrate the coating. Chemical species that are typically used as structure-directing agents in synthesizing zeolites for other uses can be used here. Prominent examples are alkylammonium cations, notably quaternary ammonium cations having molecular weights of at least about 70. Specific examples include tetramethylammonium, tetraethylammonium, tetrapropylammonium, tetrabutylammonium, benzyltrimethylammonium, and benzyltriethylammonium ions. Tetraalkylammonium cations in which each alkyl group contains from 1 to 5 carbon atoms are particularly preferred. An example of an alkylammonium cation is the tetrapropylammonium ion. Other examples of pore-filling members are tri-n-propylamine and quinuclidine. In a preferred embodiment, pore sealing agents include silanes described in U.S. Pat. No. 7,399,715, and in article: R. Cai, M. Sun, Z. Chen, R. Munoz, C. O'Neill, D. Beving, Y. Yan 2008. Ionothermal synthesis of oriented zeolite AEL films and their application as corrosion-resistant coatings, Angew. Chem. Int. Ed. 47, 525-528, and U.S. Patent Publication No.: 20100119736, which are incorporated herein by reference. An example of silane is 1,2-bis(triethoxysilyl)methane.

The amount of intracrystal pore-filling member used in any particular embodiment of this invention will depend on the nature and the porosity of the zeolite, and will be that amount that is sufficient to fill the pores and thereby render the zeolite substantially nonporous. The appropriate amount for any particular zeolite will generally be the amount used in the published method for manufacturing the zeolite (as referenced in the patents cited above) and will be readily apparent to those skilled in the art.

The thickness of the zeolite coating may vary depending on the uses contemplated for the metal surface and on the environment to which the metal surface will be exposed during use. In most cases, the appropriate thickness will be in the range of from about 0.3 micron to about 300 microns, preferably from about 5 microns to about 100 microns, more preferably from 5 to 75 um.

In some embodiments, zeolites with silicon-to-aluminum atomic ratios as low as 1.0 can be used in the practice of this invention. In certain environments, however, notably those in which the metal surface has greater susceptibility to corrosion, wear or abrasion, zeolites with higher silicon-to-aluminum atomic ratios are preferred. In these environments, preferred zeolites are those in which the silicon:aluminum atomic ratio is at least about 20:1, more preferably at least about 50:1, and even more preferably at least about 90:1. Zeolites that are alumina-free can be used as well. Further preferred zeolites are those whose topology is limited to relatively small pores, such as those of sodalite-type zeolites and pentasil-type zeolites. Pentasil-type zeolites whose pores are in the form of small intersecting channels are particularly preferred. In certain instances, the zeolites may contain phosphate. The phosphorus and aluminum can have a ratio from about 0.1 to 5.

In another aspect, the present invention provides a method for preparing a corrosion-resistant, abrasion and wear-resistant zeolite coating on the surface of a metal. The method includes contacting a zeolite-forming mixture with the surface of a metal under conditions sufficient to form a layer of zeolite coating on the surface of the metal. While methods of forming the coating are disclosed in the patent references cited above, the coatings can generally be applied either by depositing pre-formed zeolite material over the metal surface or by crystallizing the zeolite in situ on the surface from a zeolite-forming mixture. Since zeolites for example are compatible with certain organic paints, notably urethane-based paints and resins, the pre-formed zeolite can be applied as a mixture with the organic paints. The paints may also contain pigments or other components for decorative purposes, and can be applied by brushing, dipping or spraying. Once applied, the coating is cured by removing the solvent, leaving a solid coating containing the zeolite.

A preferred method of forming the zeolite coating is by immersing the metal surface in an aqueous solution of zeolite-forming materials, and doing so under conditions that will cause the materials to crystallize into the appropriate zeolite structure. Zeolite-forming materials are known in the art and cited in the patents referenced above. Preferred materials are mixtures of a silicate compound, an aluminate compound, a base, a quaternary ammonium hydroxide having a molecular weight of at least about 70, an optional phosphate compound and an optional fluoride-containing compound. Within this class of mixtures, a further preferred subclass are those that contain a tetraalkylorthosilicate, a base, an aluminate compound, and a tetraalkylammonium hydroxide. The immersion temperature and time can vary, and those that will result in, a zeolite coating of a particular thickness will be readily apparent to those skilled in the art or readily determined by routine experimentation. In most cases, the appropriate temperature will be within the range of from about 80° C. to about 200° C., preferably from about 150° C. to about 200° C. For phosphate-containing zeolite, the typical zeolite-containing mixture will contain a reactive source of phosphate (such as P₂O₅), alumina (Al₂O₃), and water, with or without a pore-filling agent, all at appropriate proportions selected to give the desired atomic ratios. When the inclusion of an additional metal, such as iron, magnesium, manganese, cobalt, or zinc, is desired in the zeolite, the metal may be introduced in the zeolite-forming mixture in the form of the metal salt, oxide, or hydroxide. Examples are iron oxide; magnesium acetate, bromide, chloride, sulfate, iodide, or nitrate; manganous acetate, bromide, or sulfate; cobalt chloride hexahydrate, sulfate, or acetate; cobaltous iodide, sulfate, bromide, or chloride; and zinc acetate, bromide, formate, iodide, or sulfate heptahydrate.

Other preferred silicate compounds for forming zeolites include, but are not limited to, an aqueous sodium silicate, a colloidal silica sol, a fumed silica, tetramethyl- and tetraethylorthosilicate (TMeOS and TEOS), a precipitated silica, sodium metasilicate, a silica gel, and ammonium hexafluorosilicate. Some preferred aluminate compounds include sodium aluminate, aluminum (Al), pseudo-boemite, Gibbsite, and aluminum isopropoxide.

In one embodiment, the phosphate compounds include aluminophosphates, silicoaluminophosphates, metal-containing aluminophosphates, and metal-containing silicoaluminophosphates. In another embodiment, the fluoride-containing compounds include hydrofluoric acid, ammonium fluoride, sodium fluoride, hydrogen fluoride pyridine, and/or tetraethylammonium fluoride.

The invention is applicable to the treatment of any metal surface that is otherwise susceptible to corrosion, wear or abrasion. Examples include ferrous metals, zinc, copper and aluminum-containing metals. Aluminum alloys, copper alloys and steel are of particular interest.

### EXAMPLES

### Example 1

### Zeolite ZSM-5 Synthesis

ZSM-5 (structure type MFI) is an aluminosilicate zeolite mineral belonging to the pentasil family of zeolites. ZSM-5's chemical formula is NaₙAlₙSi₉₆₋ₙO₁₉₂.16H₂O (0<n<27). ZSM-5 is typically prepared at high temperature and high pressure in a Teflon coated autoclave and can be prepared using varying ratios of SiO₂ and Al containing compounds.

In accordance with an exemplary embodiment, ZSM-5 was synthesized on 1.3 mm thick steel 4130 panels (McMaster Carr) in a Teflon lined autoclave (Parr Instrument Co.) using terapropylammonium hydroxide (TPAOH, 40 wt % Sachem) as the structure directing agent (SDA), and tetraethylorthosilicate (TEOS, 97 wt % Aldrich) as the silica source. The molar composition of the solution was 0.16TPAOH:0.64NaOH:TEOS:92H₂O:0.0018Al.

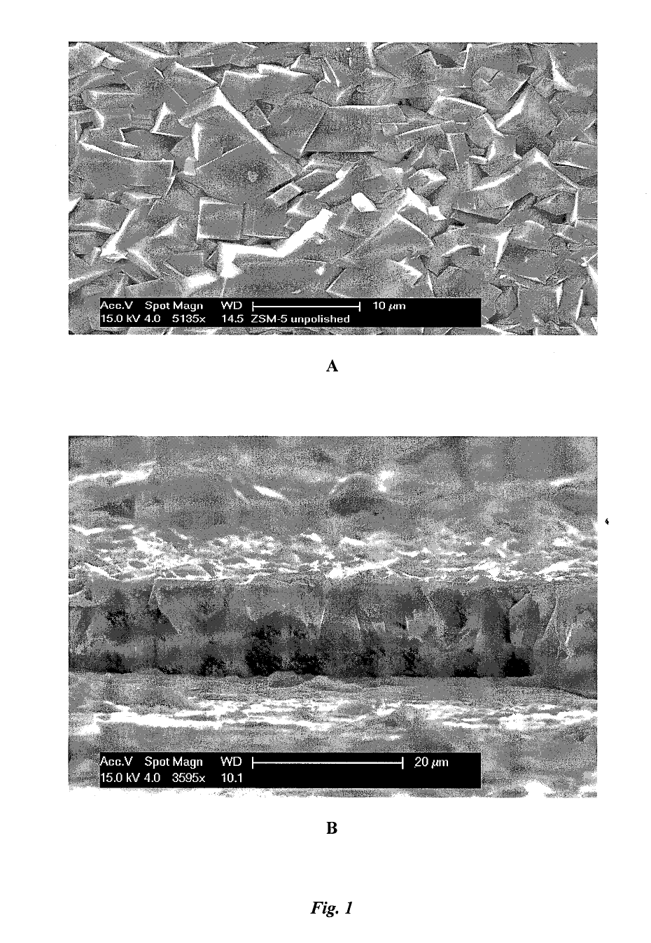

The solution synthesis procedure was as follows: 0.01040 g Al powder (200 mesh 99.95% Aldrich), 5.36 g NaOH pellets (97.5% Aldrich), and 100 g double de-ionized (DDI) water were combined and stirred with magnetic bar for 30 minutes. 17.03 g TPAOH was then added and the solution was stirred for 15 minutes. 236 g DDI water was then added and the solution was stirred for another 15 minutes. Afterwards 43.6 g TEOS was added in a dropwise fashion to the stirring solution. The solution was left to stir for 4 hours to age. 1600 ml of solution was added into autoclave with two 101.6×152.4×1.3 mm steel 4130 panels hanging vertically by thin platinum wire. Panels were fully immersed in solution with approximately (˜) 30 mm separation. Autoclave was subsequently sealed and baked at 175° C. for 24 hours. Steel was rinsed with de-ionized water and dried in air upon removal from autoclave. FIG. 1 shows ZSM5 topology (a) and cross section (b), respectively. The synthesized zeolite ZSM-5 coating was approximately 12 μm in thickness.

### Example 2

### Mechanical Properties of ZSM-5 Compared to Chromium and Cadmium

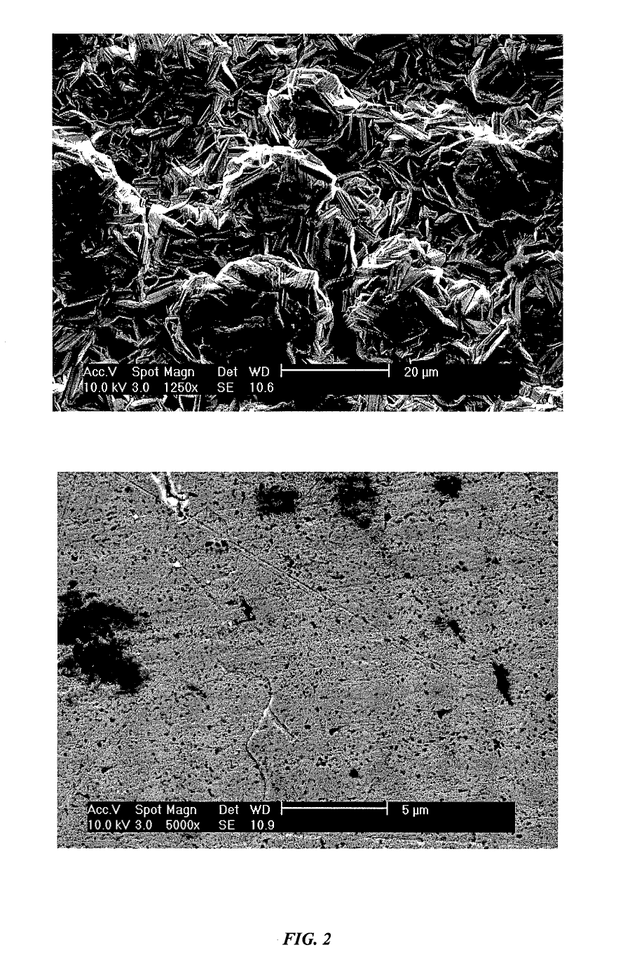

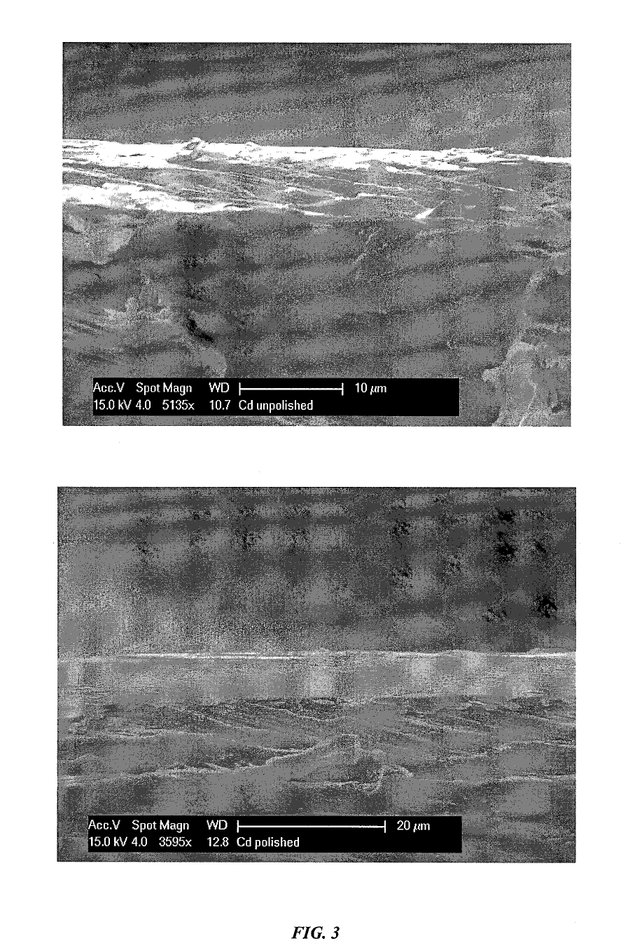

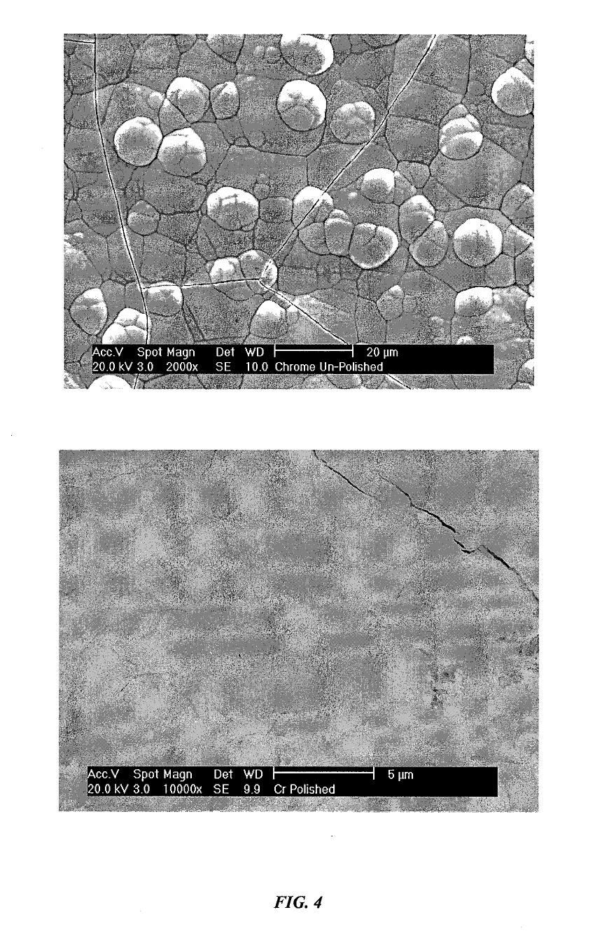

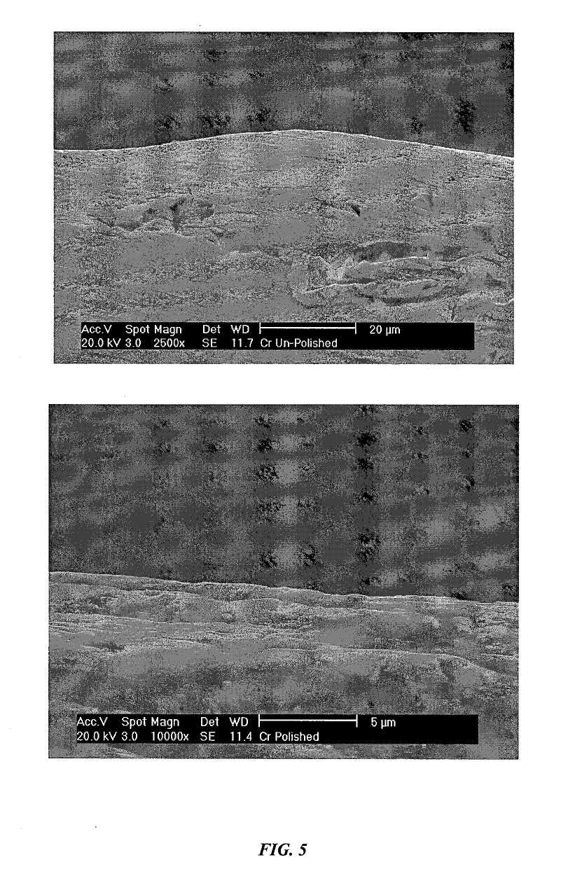

In accordance with another exemplary embodiment, chromium and cadmium coatings were electroplated with steel 4130 alloy as the substrate by Multichrome Multiplate (Inglewood, Calif., United States of America) to industrial specifications, SAE International, Standard. SAE-AMS-2406: Plating, Hard Chromium. 2007, and SAE International, Standard. SAE-AMS-QQ-P416. Plating, Cadmium (Electrodeposited, 2004, respectively. Scanning electron microscope (SEM) images of the chromium and cadmium coatings are shown in FIGS. 2-5. For mechanical characterization, all surfaces (chromium, cadmium, plain steel, and ZSM5) were first polished to less than (<) 10 nm surface roughness using a Buehler Ecomet IV with hand force on various pads with diamond paste and alumina slurry.

Hardness and elastic modulus were characterized for each coating using nanoindentation techniques provided by a Hysitron UBi1 nanomechanical test instrument (Hysitron Inc, Minneapolis Minn.) with a Berkovich indenter tip of a nominal tip radius of 150 μm and calculation methods presented by Oliver and Pharr, W. C. Oliver and G. M. Pharr, An Improved Technique for Determining Hardness and Elastic-Modulus Using Load and Displacement Sensing Indentation Experiments, Journal of Materials Research, 1992, 7(6): p. 1564-1583. All indentations featured a 3 step symmetric loading/unloading procedure (10 seconds linear ramping of load, 5 seconds hold at maximum load, 10 seconds linear unloading) with maximum loads varying from 500-5000 μN. Table 1 shows hardness and elastic modulus results. Hardness, indicative of resistance to plastic (permanent) deformation, is one of the most important parameters for wear resistance. It can be seen that the ZSM-5 coating has over an order of magnitude higher hardness than cadmium (6.31±0.24 GPa compared to 0.53±0.06 GPa) and about half of the hardness of chromium (6.31±0.24 GPa compared to 12.12±0.33 GPa).

TABLE 1
Elastic modulus, hardness, and resilience comparisons
between Cr, ZSM-5, steel 4130, and cadmium.

| | Elastic Modulus | Hardness | Resilience |
|---|---|---|---|
| Sample | (GPa) | (GPa) | (MPa) |
| Chromium | 265.6 ± 11.7 | 12.1 ± 0.3 | 30 |
| ZSM-5 | 51.0 ± 2.5 | 6.3 ± 0.2 | 43 |
| Steel 4130 | 94.0 ± 12.5 | 2.8 ± 0.2 | 4.6 |
| Cadmium | 80.6 ± 13.0 | 0.5 ± 0.1 | 0.2 |

Nanoscratch testing was used to gage wear resistance more thoroughly since lateral scratching more suitably fits the model of sliding wear behavior in materials. Nanoscratch was performed with the Hysitron UBi1 and the same Berkovich tip with a nominal radius of 150 μm. All scratches featured a 5 step procedure: 5 seconds linear load application, 3 seconds hold at maximum load, 30 seconds scratch 4-5 μm in length while holding maximum normal load, 3 seconds hold at maximum load, and 5 seconds linear unloading. Maximum normal scratch loads ranged from 250-2500 μN.

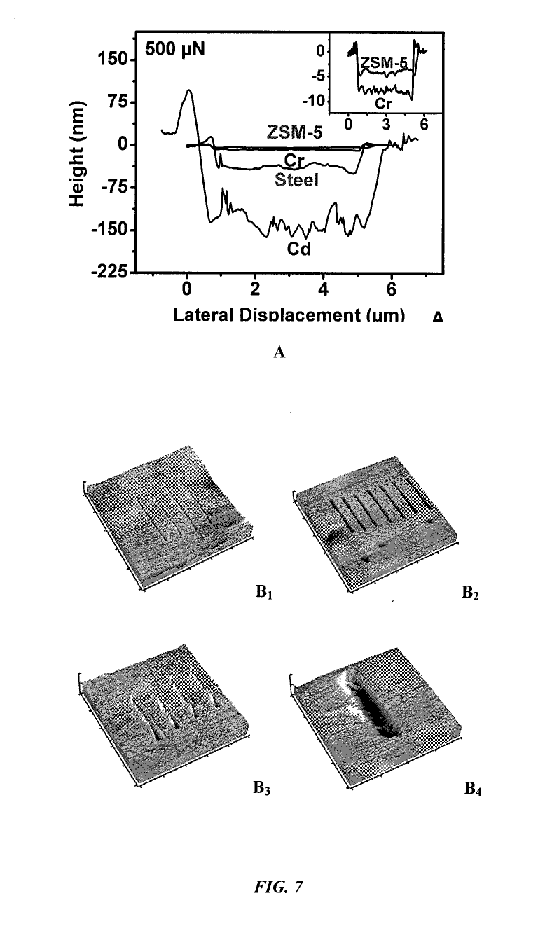

FIG. 7(A) shows scratch profiles for a 500 μN scratch on each coating; and FIGS. 7(B-E) show scanning probe microscopy (SPM) images of 500 μN scratches. Scratch depth indicates level of wear resistance and at a 500 μN scratch load, the ZSM-5 coating performed best with depth of 4.18±0.66 nm followed by chromium coating (9.12±1.04 nm), steel (36.95±5.51 nm), and cadmium coating (111.00±27.42 nm). It is clearly evident that the ZSM-5 coating is much more wear resistant than the cadmium coating with a scratch depth an order of magnitude shallower even at the low load of 500 μN.

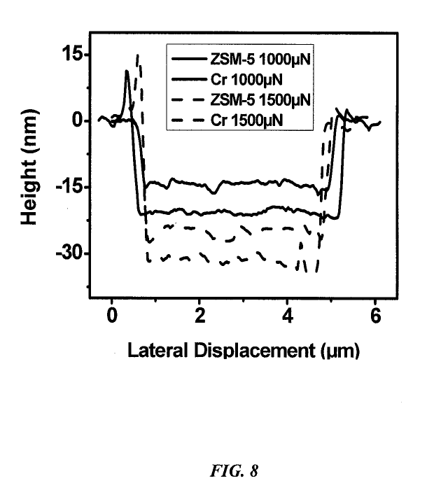

FIG. 8 shows scratch profiles for the chromium and ZSM-5 coatings at 1000 μN and 1500 μN. At 1000 μN, the ZSM-5 coating has scratch depth of 14.21±1.36 nm, approximately (˜) 30% less than that of chromium with depth 19.74±0.96 nm. At 1500 μN, the ZSM-5 coating has scratch depth of 24.00±1.77 nm, now only approximately (˜) 20% less than that of chromium with depth 29.90±1.61 nm.

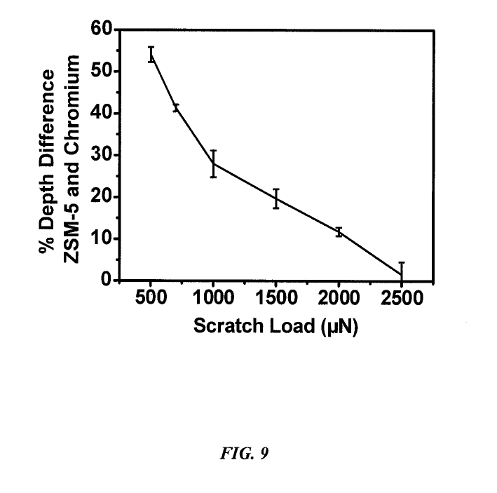

Higher loading follows a similar trend with the percentage difference in scratch depth among ZSM-5 and chromium steadily decreasing as shown in FIG. 9. ZSM-5 is able to maintain an advantage incurring less plastic deformation (meaning more wear resistance) at scratch loads less than 2500 μN, which is due to the uniquely high hardness and low modulus coupling present in ZSM-5 and gives rise to high resilience.

Resilience is a property that governs how much deformation energy a material can absorb in the elastic regime and is directly related to the elastic strain limit of the material. Although hardness is usually directly related to the wear performance, one must also consider resilience. Materials with higher resilience are expected to recover from a deformed state more readily. The modulus of resilience is given by:

$${U}_{r} = \frac{{σ}_{y}^{2}}{2 E}$$

where Uᵣ is the modulus of resilience, σ_{y} is the yield stress, and E is the Young's modulus of the material. By using Tabor's approximation of yield stress with hardness in compressive tests, one can assume

$${σ}_{y} \approx \frac{H}{3}$$

then the modulus of resilience can be simplified as:

$${U}_{r} \approx \frac{{H}^{2}}{18 E}$$

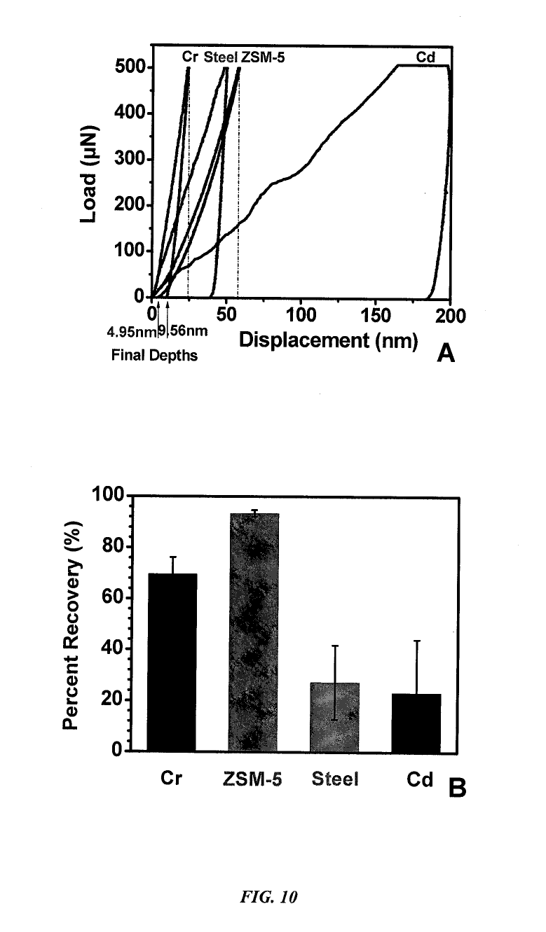

Utilizing the average hardness and modulus values, the resilience of the four materials are presented in Table 1. It can be seen that the high hardness and low modulus gives ZSM-5 coatings about 30% higher resilience than chromium coatings. It can be appreciated that in accordance with an exemplary embodiment, ZSM-5 coatings show less plastic deformation with lower hardness. The higher resilience provides ZSM-5 coatings with the ability to absorb and recover deformation much more efficiently than the chromium coatings. This effect is shown in FIG. 10 where the ZSM-5 coating recovers over 90% of the deformation taken in a 500 μN nanoindentation. The resilience of ZSM-5 also accounts for additional coating flexibility since the coating can deform elastically with ease. This allows ZSM-5 to have a decreased chance of surface cracking during substrate bending or torsion, a problem common to traditional wear coatings. At low to moderate loads (0-2500 μN), elastic deformation dominates therefore the resilience allows ZSM-5 coatings to have superior wear resistance. Chromium coatings are more wear resistant at scratch loads above 2500 μN because plastic deformation dominates at higher loads and the advantage of resilience is lost.

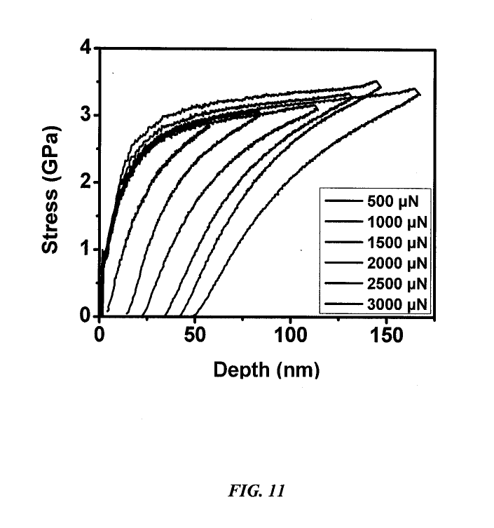

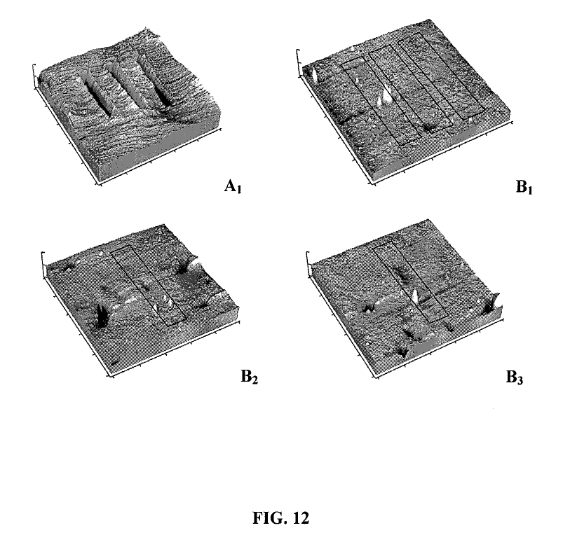

Although chromium eventually becomes more wear resistant, the stresses subjected to the ZSM-5 coating prior to the transition point (2500 μN) are well beyond the range of normal stresses (σ=F_{Normal}/Area) seen in many practical applications of hard chrome. In the range where ZSM-5 is more wear resistant, the highest normal stress was approximately (˜) 3.5 GPa (FIG. 11), whereas the maximum stresses on chromium coatings in pistons and chains rarely exceed 500 MPa. Perhaps the instantaneously high local stresses in bearings and gears are highest at approximately 1 to 4 GPa, but even then the ZSM-5 coating is more wear resistant throughout most of that range. It should be noted that the stresses involved in a macroscale pin-on-disk test, the industrial standard in wear testing, are less than that of nanoscratch being within the megapascal range. This is due to the load being applied with a blunter tip (6 mm diameter sphere); an effect that can be mimicked by performing nanoindentation with a conical tip (5 μm radius). The larger tip once again showed the dominance of resilience in ZSM-5 clearly with little plastic deformation occurring even at loads in excess of 8 mN on the ZSM-5 coating while visible deformation was seen on the chromium coating starting at approximately (˜) 2 mN (FIG. 12). This is due to the penetration of the blunt tip being absorbed over a larger area on the ZSM-5 coating therefore creating more recoverable elastic deformation.

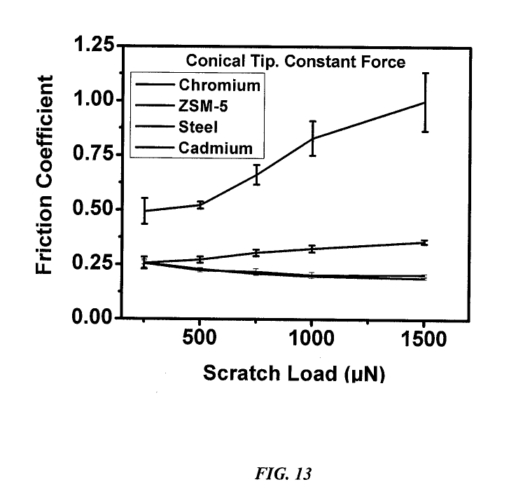

FIG. 13 shows the coefficient of kinetic friction for ZSM-5, chromium, and cadmium measured during scratch tests with a diamond conical tip. ZSM-5 has lower coefficient of friction than cadmium and matches the performance of chromium at all loads investigated.

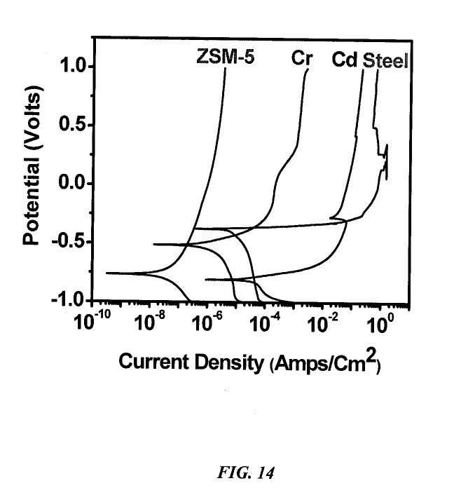

FIG. 14 shows results from DC polarization testing using a Solartron potentiostat (SI 1287) in three electrode configuration and 0.856M NaCl as the corrosive medium. ZSM-5, leftmost curve, has greatest corrosion resistance with the cathodic region (upper portion following equilibrium spike) having 3 orders of magnitude less current density than that of chromium, 5 orders of magnitude less than that of cadmium, and 6 orders of magnitude less than that of bare steel.

With these results, ZSM-5 coatings prove to be suitable alternatives to cadmium coatings by displaying orders of magnitude greater wear and corrosion resistance. The hydrothermal synthesis can be easily incorporated to coat any parts that cadmium is currently used for. ZSM-5 coatings can also be used as a substitute for chromium in many applications since ZSM-5 is more wear resistant in almost all areas where hard chrome is currently used. ZSM-5 coatings match the lubricity of chromium and have orders of magnitude higher corrosion resistance over chromium coatings.

It will be understood that the foregoing description is of the preferred embodiments, and is, therefore, merely representative of the article and methods of manufacturing the same. It can be appreciated that many variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims.

What is claimed is:

1. A composition of matter comprising: a substrate of a metal that is susceptible to wear or abrasion; and a wear-resistant coating deposited on the surface of said substrate, said coating comprising a polycrystalline zeolite coating.

2. The composition of matter of claim 1, wherein said zeolite is porous, non-porous or a combination thereof.

3. The composition of matter of claim 1, wherein said zeolite contains an intercrystal void, an intracrystal pore or a combination thereof.

4. The composition of matter of claim 1, wherein said zeolite contains an intracrystal pore-filing agent and/or an intercrystal pore-sealing agent.

5. The composition of matter of claim 4, wherein the intracrystal pore-filing agent, the intercrystal pore-sealing agent or a combination thereof is of sufficient molecular size and in sufficient quantity to render said zeolite non-porous.

6. The composition of matter of claim 4, wherein the intercrystal pore-sealing agent is a silane.

7. The composition of matter of claim 1, wherein the wear-resistant coating has a thickness of from about 0.3 micron to about 300 micron.

8. The composition of matter of claim 1, wherein the zeolite has a silicon to aluminum molar ratio of at least 20:1.

9. The composition of matter of claim 1, wherein the zeolite is aluminum free.

10. The composition of matter of claim 1, wherein the zeolite has a topology substantially equal to that of a member selected from the group consisting of MFI, MEL, MTW, MTN, MTT, RUT, ITW, FER, IFR, STT, STF, AFI, CFI, MWW, AST, ITE, CON, BEA, CHA, ISV, LTA.

11. The composition of matter of claim 1, wherein the zeolite is a phosphate-containing zeolite selected from the group consisting of aluminophosphates, silicoaluminophosphates, metal-containing aluminophosphates, and metal-containing silicoaluminophosphates.

12. The composition of matter of claim 1, wherein the substrate is a metal selected from the group consisting of aluminum-containing metals, iron-containing metals, and zinc-containing metals.

13. The composition of matter of claim 1, wherein the substrate is an aluminum alloy.

14. A composition of matter comprising: a substrate of a metal that is susceptible to corrosion; and a corrosion-resistant coating deposited on the surface of said substrate, said coating comprising a zeolite containing a intracrystal pore-filing agent retained in the zeolite's crystal structure, said pore-filing agent being of sufficient molecular size and in sufficient quantity to render said zeolite non-porous.

15. The composition of matter of claim 14, wherein the pore-filling agent is an organic amine or a silane.

16. The composition of matter of claim 1, wherein the coating comprises a zeolite and a polymer to form a composite.

17. A method for preparing a wear-resistant zeolite coating on the surface of a metal, said method comprising:
contacting a zeolite-forming mixture with the surface of a metal substrate under conditions sufficient to form a layer of zeolite coating deposited on the surface of the metal substrate.

18. The method of claim 17, wherein said contacting comprises immersing the surface of the metal substrate in an aqueous solution of zeolite-forming mixture under conditions sufficient to form a layer of zeolite coating on the surface of the metal, wherein the zeolite-forming mixture optionally comprises a structure-directing agent.

19. The method of claim 18 further comprising: washing and drying the zeolite.

20. The method of claim 18, wherein the zeolite-forming mixture further comprises a silicate compound.

21. The method of claim 18, wherein said conditions comprise an elevated temperature.

22. The method of claim 21, wherein the temperature is between 80 and 200° C.

23. The method of claim 17, wherein said zeolite is a phosphate-containing zeolite selected from the group consisting of aluminophosphates, silicoaluminophosphates, metal-containing aluminophosphates, and metal-containing silicoaluminophosphates.

24. The method of claim 18, wherein the zeolite-forming mixture is a mixture of a silicate compound, an aluminum compound, a base, and a quaternary ammonium hydroxide.

25. The method of claim 24, wherein the aluminum compound is aluminum powder.

26. The method of claim 24, wherein the base is NaOH.

27. The method of claim 24, wherein the zeolite-forming mixture is a mixture of a tetraalkylorthosilicate, an aluminate, a base, and a tetraalkylammonium hydroxide and said conditions comprise a temperature of from about 80° C. to about 200° C.

28. The method of claim 24, wherein the zeolite-forming mixture is a mixture of tetraethylorthosilicate, an aluminate, a base, and tetrapropylammonium hydroxide, and said conditions of step (a) comprise a temperature of from about 150° C. to about 200° C.

29. A method for protecting the surface of a metal substrate against wear and abrasion, said method comprising:
forming a layer of zeolite coating on the surface of the metal substrate.

30. The method of claim 29, wherein the zeolite coating comprises zeolite having a porous, non-porous or a combination thereof.

31. The method of claim 29, wherein the metal is selected from the group consisting of aluminum-containing metals, iron-containing metals, and zinc-containing metals.

32. The method of claim 29, wherein the zeolite coating comprises a zeolite with an intracrystal pore-filing agent retained in the crystal structure of the zeolite to render the zeolite substantially non-porous.

33. The method of claim 32, wherein the pore-filing agent is alkylammonium cation.

34. A method for protecting the surface of a metal substrate against corrosion, said method comprising:
forming a layer of non-porous zeolite coating on the surface of the metal, wherein the non-porous zeolite comprises an intercrystal pore-sealing agent, an intracrystal pore-filing agent or a combination thereof, wherein each of the agents retained in its crystal structure being of sufficient molecular size and in sufficient quantity to render said zeolite non-porous.
